(19) United States
(12) Patent Application Publication
(10) Pub. No.: US 2026/0368554 A1
(43) Pub. Date: Nov. 19, 2026

(54) KNOWLEDGE GRAPH-BASED INFORMATION PROCESSING METHOD, APPARATUS, COMPUTER-READABLE STORAGE MEDIUM, AND COMPUTER DEVICE

(71) Applicant: SHANGHAI BINGJIAN INFORMATION TECHNOLOGY CO., LTD., Shanghai (CN)

(72) Inventors: Lingyun GU, Shanghai (CN); Zhipan GUO, Shanghai (CN); Wei WANG, Shanghai (CN); Haiquan LI, Shanghai (CN)

(21) Appl. No.: 19/740,178

(22) Filed: Jul. 13, 2026

Related U.S. Application Data
(63) Continuation of application No. PCT/CN2025/077800, filed on Feb. 18, 2025.

(30) Foreign Application Priority Data
Apr. 25, 2024 (CN) 202410501100.6

(51) Int. Cl. G06N 5/022

(52) U.S. Cl. CPC G06N 5/022

(57) ABSTRACT

A knowledge graph-based information processing method and system are provided. The method acquires a target operation scheduling knowledge graph and loads it into an entity recognition network to generate a target entity definition domain associated with each target node. According to the target entity definition domain, a target entity can be identified from the target operation scheduling knowledge graph. By performing network parameter learning based on the first knowledge inference error, the entity recognition network can identify entities more accurately.

### CROSS-REFERENCE TO RELATED APPLICATIONS

The present disclosure is a continuation application of international application PCT/CN2025/077800 filed on Feb. 18, 2025, which claims priority to the Chinese patent application with an application No. of 202410501100.6, entitled KNOWLEDGE GRAPH-BASED INFORMATION PROCESSING METHOD, APPARATUS, COMPUTER-READABLE STORAGE MEDIUM, AND COMPUTER DEVICE, and filed on May 25, 2024 before the Chinese Patent Office, the contents of which are incorporated herein by reference in their entirety.

### TECHNICAL FIELD

The disclosure relates to the field of artificial intelligence (AI) technologies, and more specifically, to a knowledge graph-based information processing method, apparatus, computer-readable storage medium, and computer device.

### BACKGROUND ART

In the information age, data volumes are growing and extracting useful insights from them has become a key challenge. Knowledge graphs, as a way to represent and use knowledge, have been widely used in fields such as information retrieval, intelligent recommendation, and semantic search. In computing scheduling, for instance, knowledge graphs model complex computing tasks, resources, and the dependencies therebetween, facilitating efficient resource allocation and task scheduling.

Traditional knowledge graphs usually rely on predefined rules or patterns for information extraction and entity recognition, but such methods have certain limitations. First, preset rules or patterns may not cover all entity types and relationship types, thus causing some important information to be ignored. Second, the lack of effective mechanisms to handle uncertainty and fuzziness in knowledge graphs affects the accuracy of results. Finally, as knowledge graphs expand, processing complexity and computational costs increase, reducing system performance. In short, traditional technical solutions often rely on manually defined rules and features, and have poor adaptability to complex and changeable operation scheduling scenarios. Moreover, these methods face problems such as large computational load and low recognition accuracy when processing large-scale knowledge graphs.

### SUMMARY OF THE INVENTION

In view of this, the purpose of the disclosure is to provide a knowledge graph-based information processing method, apparatus, computer-readable storage medium, and computer device.

According to a first aspect of the disclosure, there is provided a knowledge graph-based information processing method including the steps as follows.

acquiring a target operation scheduling knowledge graph, and loading the target operation scheduling knowledge graph into an entity recognition network to generate a target entity definition domain associated with each target node of the target operation scheduling knowledge graph; and

identifying a target entity from the target operation scheduling knowledge graph according to the target entity definition domain, wherein the entity recognition network performs network parameter learning based on a first knowledge inference error, the first knowledge inference error being calculated according to a first estimated definition domain recognized by the entity recognition network for each first node in at least two first example operation scheduling knowledge graphs and a first annotated entity definition domain for each said first node, the at least two first example operation scheduling knowledge graphs comprising a prior operation scheduling knowledge graph and at least two reconstructed operation scheduling knowledge graphs generated by applying at least two different knowledge reconstruction strategies to a first prior entity in the prior operation scheduling knowledge graph, wherein a knowledge association parameter of the first prior entity among the at least two first example operation scheduling knowledge graphs meets a first preset requirement.

In a possible implementation of the first aspect, generating the entity recognition network comprises:

acquiring a first example operation scheduling knowledge graph sequence comprising at least two first example operation scheduling knowledge graphs, the at least two first example operation scheduling knowledge graphs comprising the prior operation scheduling knowledge graph and the at least two reconstructed operation scheduling knowledge graphs generated by applying at least two different knowledge reconstruction strategies to the first prior entity in the prior operation scheduling knowledge graph, wherein the knowledge association parameter of the first prior entity among the at least two first example operation scheduling knowledge graphs meets the first preset requirement, and each first example operation scheduling knowledge graph has the first annotated entity definition domain associated with each first node thereof;

loading each of the first example operation scheduling knowledge graphs into the entity recognition network to generate the first estimated definition domain associated with each first node of the first example operation scheduling knowledge graph;

outputting the first knowledge inference error according to the first estimated definition domain and the first annotated entity definition domain associated with each first node of the first example operation scheduling knowledge graph; and

performing network parameter learning on the entity recognition network according to the first knowledge inference error.

In a possible implementation of the first aspect, performing network parameter learning on the entity recognition network according to the first knowledge inference error comprises:

acquiring a second example operation scheduling knowledge graph sequence comprising at least two second example operation scheduling knowledge graphs parsed from a same operation scheduling knowledge graph, the second example operation scheduling knowledge graphs comprising a second prior entity, the second example operation scheduling knowledge graphs having a second annotated entity definition domain associated with each second node thereof;

loading each of the second example operation scheduling knowledge graphs into the entity recognition network to generate a second estimated definition domain associated with each second node of the second example operation scheduling knowledge graph;

outputting a second knowledge inference error according to the second estimated definition domain and the second annotated entity definition domain associated with each second node of the second example operation scheduling knowledge graph; and

performing network parameter learning on the entity recognition network according to the first knowledge inference error and the second knowledge inference error.

In a possible implementation of the first aspect, generating the second annotated entity definition domain comprises:

loading each of the second example operation scheduling knowledge graphs into a prior recognition network of the entity recognition network to generate a third estimated definition domain associated with each second node of the second example operation scheduling knowledge graph, and using the third estimated definition domain as the second annotated entity definition domain.

In a possible implementation of the first aspect, generating the prior recognition network comprises:

acquiring a third example operation scheduling knowledge graph sequence comprising at least two third example operation scheduling knowledge graphs, the third example operation scheduling knowledge graphs comprising a third prior entity, the third example operation scheduling knowledge graphs having a third annotated entity definition domain associated with each third node thereof, wherein a count of the third example operation scheduling knowledge graphs is greater than a count of the first example operation scheduling knowledge graphs;

loading each of the third example operation scheduling knowledge graphs into the prior recognition network to generate a fourth estimated definition domain associated with each third node of the third example operation scheduling knowledge graph;

outputting a third knowledge inference error according to the fourth estimated definition domain and the third annotated entity definition domain associated with each third node of the third example operation scheduling knowledge graph; and

performing network parameter learning on the prior recognition network according to the third knowledge inference error.

In a possible implementation of the first aspect, acquiring the first example operation scheduling knowledge graph sequence comprises:

acquiring the prior operation scheduling knowledge graph, the prior operation scheduling knowledge graph comprising the first prior entity, the prior operation scheduling knowledge graph having the first annotated entity definition domain associated with each first node thereof;

applying a knowledge reconstruction strategy under a same stage to the first prior entity and the first annotated entity definition domain in the prior operation scheduling knowledge graph to generate a reconstructed operation scheduling knowledge graph subsequent to the prior operation scheduling knowledge graph and an associated first annotated entity definition domain, wherein the knowledge association parameter of the first prior entity between the prior operation scheduling knowledge graph and the reconstructed operation scheduling knowledge graph meets the first preset requirement;

applying the knowledge reconstruction strategy under the same stage to the first prior entity and the first annotated entity definition domain in the reconstructed operation scheduling knowledge graph to generate an iterative reconstructed operation scheduling knowledge graph, wherein the knowledge association parameter of the first prior entity between associated reconstructed operation scheduling knowledge graphs meets the first preset requirement;

cyclically performing the step of applying the knowledge reconstruction strategy under the same stage to the first prior entity and the first annotated entity definition domain in the reconstructed operation scheduling knowledge graph to generate an iterative reconstructed operation scheduling knowledge graph until a count of reconstructed operation scheduling knowledge graphs meets a second preset requirement; and

determining the first example operation scheduling knowledge graph sequence based on the prior operation scheduling knowledge graph and at least two reconstructed operation scheduling knowledge graphs.

In a possible implementation of the first aspect, determining that the knowledge association parameter of the first prior entity among the at least two first example operation scheduling knowledge graphs meets the first preset requirement comprises:

for each prior node of the first prior entity on the prior operation scheduling knowledge graph, obtaining a stage at which the prior node is located in each of the at least two first example operation scheduling knowledge graphs; and

if, for each said prior node, a deviation between the stages at which the prior node is located in any two of the first example operation scheduling knowledge graphs is less than a first set deviation, outputting that the knowledge association parameter of the first prior entity among the at least two first example operation scheduling knowledge graphs meets the first preset requirement.

In a possible implementation of the first aspect, determining that the knowledge association parameter of the first prior entity among the at least two first example operation scheduling knowledge graphs meets the first preset requirement comprises:

decomposing each of the first example operation scheduling knowledge graphs into operation scheduling knowledge units, and assigning a unit label to each operation scheduling knowledge unit according to a participating stage of the operation scheduling knowledge unit; and

if the first prior entity is located in the operation scheduling knowledge unit associated with the same unit label in each of the first example operation scheduling knowledge graphs, outputting that the knowledge association parameter of the first prior entity among the at least two first example operation scheduling knowledge graphs meets the first preset requirement.

In a possible implementation of the first aspect, the target operation scheduling knowledge graph comprises a plurality of continuous target operation scheduling knowledge graphs, the target entity definition domain comprises a target entity definition subdomain for each of the target operation scheduling knowledge graphs, and loading the target operation scheduling knowledge graph into the entity recognition network to generate the target entity definition domain associated with each target node of the target operation scheduling knowledge graph comprises:

for a currently traversed target operation scheduling knowledge graph, acquiring a previously generated target operation scheduling knowledge graph and a target entity definition subdomain of the previously generated target operation scheduling knowledge graph; and

loading the currently traversed target operation scheduling knowledge graph, the previously generated target operation scheduling knowledge graph, and the target entity definition subdomain of the previously generated target operation scheduling knowledge graph into the entity recognition network to generate a target entity definition subdomain associated with each target node of the currently traversed target operation scheduling knowledge graph.

According to a second aspect of the disclosure, there is provided an operation query device comprising a machine-readable storage medium and a processor, the machine-readable storage medium storing machine-executable instructions, wherein when the processor executes the machine-executable instructions, the operation query device implements the knowledge graph-based information processing method as described above.

According to a third aspect of the disclosure, there is provided a computer-readable storage medium having computer-executable instructions stored therein, which when executed, implement the knowledge graph-based information processing method as described above.

According to any of the above aspects, the technical effects of the disclosure are as follows.

The disclosure acquires a target operation scheduling knowledge graph and loads it into an entity recognition network to generate a target entity definition domain associated with each target node, thereby achieving accurate identification of entities in the knowledge graph. Further, a target entity is identified from the knowledge graph according to the target entity definition domain, improving the accuracy and efficiency of entity recognition. In addition, the entity recognition network performs network parameter learning based on a first knowledge inference error calculated from differences between estimated definition domains and annotated entity definition domains for nodes in multiple example operation scheduling knowledge graphs, thereby enhancing the learning ability of the entity recognition network for entity definition. The at least two example knowledge graphs include a prior knowledge graph and reconstructed knowledge graphs generated by applying different knowledge reconstruction strategies, and the knowledge association parameters of the prior entity among these example knowledge graphs meet the preset requirement, further enriching the diversity and representativeness of learning samples and improving the generalization ability and robustness of the entity recognition network.

In other words, the disclosure acquires a target operation scheduling knowledge graph and loads it into an entity recognition network to generate a target entity definition domain associated with each target node. According to the target entity definition domain, a target entity can be identified from the target operation scheduling knowledge graph. By performing network parameter learning based on the first knowledge inference error, the entity recognition network can identify entities more accurately. Thus, using a knowledge graph and an entity recognition network improves the accuracy of entity recognition; secondly, a novel way of calculating the knowledge inference error helps optimize the network parameter learning process and improves network performance; finally, using a prior operation scheduling knowledge graph and reconstructed operation scheduling knowledge graphs makes entity recognition more consistent with preset knowledge association parameters, further improving the accuracy and efficiency of entity recognition.

### BRIEF DESCRIPTION OF THE DRAWINGS

In order to more clearly describe the technical solutions in the embodiments of the disclosure, the drawings required for use in the embodiments will be briefly introduced below. It should be understood that the following drawings only show certain embodiments of the disclosure and should not be considered as limiting the scope. For those of ordinary skill in the art, other related drawings can also be obtained based on these drawings without creative work.

FIG. 1 is a schematic flow diagram of the knowledge graph-based information processing method provided by an embodiment of the disclosure.

FIG. 2 shows a component structure diagram of an operation query device for implementing the above knowledge graph-based information processing method provided by an embodiment of the disclosure.

### DETAILED DESCRIPTION OF PREFERRED EMBODIMENTS

Those skilled in the art will understand that, unless specifically stated otherwise, the singular forms “a”, “an”, “said”, and “the” used herein may also include the plural forms. It should be further understood that the terms “comprising” and “including” used in the embodiments of the disclosure mean that the corresponding features may be implemented as the presented features, information, data, steps, operations, elements, and/or components, but do not exclude implementation as other features, information, data, steps, operations, elements, components, and/or combinations thereof supported by the technical field. It should be understood that when an element is referred to as being “connected” or “coupled” to another element, it can be directly connected or coupled to the other element, or it can mean that the one element and the other element are connected through an intermediate element. In addition, “connected” or “coupled” as used herein may include wireless connection or wireless coupling. The term “and/or” used herein indicates at least one of the items defined by the term, for example, “A and/or B” can be implemented as “A”, or as “B”, or as “A and B”.

In order to make the purpose, technical solutions, and advantages of the disclosure clearer, the embodiments of the disclosure will be described in further detail below with reference to the accompanying drawings. The technical solutions of the embodiments of the disclosure and the technical effects produced by the technical solutions of the disclosure are described below through the description of several exemplary implementations. It should be noted that the following implementations may refer to, draw on, or be combined with each other, and repeated description of the same terms, similar features, and similar implementation steps in different implementations will not be repeated.

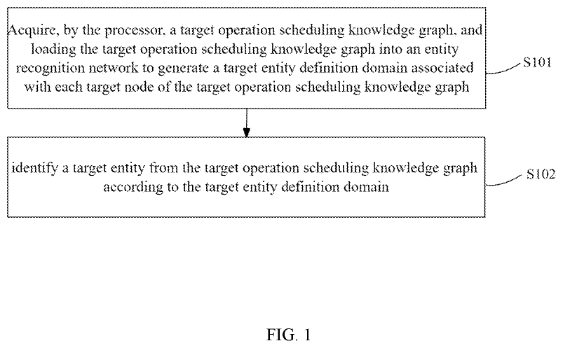

FIG. 1 shows a schematic flow diagram of the knowledge graph-based information processing method and system provided by an embodiment of the disclosure. It should be understood that in other embodiments, the order of some steps in the knowledge graph-based information processing method of this embodiment may be shared with each other as needed, or some of the steps may be omitted or maintained. The detailed steps of the knowledge graph-based information processing method include:

S10: acquiring a target operation scheduling knowledge graph, and loading the target operation scheduling knowledge graph into an entity recognition network to generate a target entity definition domain associated with each target node of the target operation scheduling knowledge graph.

In this embodiment, assume that an operation query device 1 is performing a complex operation scheduling task that involves a large amount of data computation and scheduling decisions. In order to improve the efficiency and accuracy of operation scheduling, the operation query device needs to use knowledge graph technology to assist decision-making.

For example, the operation query device 1 first acquires the data structure of the target operation scheduling knowledge graph from its internal storage 11 or an external data source 12. The target operation scheduling knowledge graph is a complex network composed of nodes and edges, where nodes represent various operation entities (such as data, algorithms, computing resources, etc.) and edges represent relationships between these entities (such as data dependencies, computation order, etc.).

Then, the operation query device 1 loads the acquired target operation scheduling knowledge graph into a pre-trained entity recognition network. The entity recognition network is a deep learning model capable of parsing and learning the input knowledge graph to identify various entities in the knowledge graph. In detail, the entity recognition network, by learning the target operation scheduling knowledge graph, generates a target entity definition domain for each target node in the target operation scheduling knowledge graph. The target entity definition domain is an abstract concept space for describing and defining the features and attributes of the entity represented by the target node.

In detail, the operation query device 1 may retrieve and extract a knowledge graph related to operation scheduling from a specified data source. For example, the operation query device 1 downloads a knowledge graph file named ‘operation scheduling strategy’ from internal storage 11 (e.g., an internal database) or an external data source 12 (e.g., external cloud storage). The knowledge graph file contains nodes such as operation tasks, computing resources, scheduling rules, and the relationships therebetween. The target operation scheduling knowledge graph may refer to the knowledge graph in the field of operation scheduling that the operation query device 1 needs to process and analyze. For example, in the operation scheduling system of the operation query device 1, there is a knowledge graph that specifically describes how different operation tasks are assigned to various computing nodes, as well as the dependencies and execution order between these tasks. Thus, the operation query device 1 runs a deep learning framework (such as TensorFlow or PyTorch), loads a pre-trained entity recognition network therein, and passes the target operation scheduling knowledge graph as input data to the entity recognition network. The entity recognition network is a neural network model capable of automatically identifying and classifying entities in a knowledge graph. It can detect nodes in the knowledge graph and classify them into different entity types (such as operation tasks, computing resources, etc.) according to the features and attributes of the nodes. That is, the entity recognition network generates a definition domain or range describing the features and attributes for each target node in the knowledge graph.

For a node “matrix multiplication operation” in the target operation scheduling knowledge graph, the entity recognition network generates a definition domain that may contain feature information such as the dimensions of the operation, data type, required computing resources, etc. The target node may refer to a node in the target operation scheduling knowledge graph that is of interest for a specific operation or analysis. For example, in the operation scheduling knowledge graph, the operation query device 1 may specifically focus on nodes representing large operation tasks or key computing resources, and these nodes are target nodes. Thus, the target entity definition domain is generated for the target node to describe and define the specific range and feature space of the entity represented by the node. For example, for the target node “high-performance computing operation query device 1”, the target entity definition domain may include detailed information such as the model, configuration, computing power, storage capacity, etc., of the operation query device.

S11: identifying a target entity from the target operation scheduling knowledge graph according to the target entity definition domain.

In this embodiment, the entity recognition network performs network parameter learning based on a first knowledge inference error. The first knowledge inference error is calculated according to a first estimated definition domain recognized by the entity recognition network for each first node in first example operation scheduling knowledge graphs and a first annotated entity definition domain for each said first node. At least two first example operation scheduling knowledge graphs include a prior operation scheduling knowledge graph and at least two reconstructed operation scheduling knowledge graphs generated by applying at least two different knowledge reconstruction strategies to a first prior entity in the prior operation scheduling knowledge graph, wherein a knowledge association parameter of the first prior entity among the at least two first example operation scheduling knowledge graphs meets a first preset requirement.

The target entity herein refers to an entity node in the target operation scheduling knowledge graph that is specifically focused on or needs to be identified. For example, suppose there is a node representing a video encoding/decoding task in the target operation scheduling knowledge graph; during the operation scheduling process of the operation query device 1, this task node may be a target entity requiring special attention.

The first knowledge inference error refers to the error generated by the entity recognition network when recognizing nodes in the example operation scheduling knowledge graphs, and is used to measure the difference between the accuracy of the network's recognition and the actual annotation. For example, the entity recognition network attempts to recognize a node “image rendering task” in an example operation scheduling knowledge graph and generates an estimated definition domain for it; at the same time, the node has an annotated entity definition domain as the ground truth. By comparing the difference between the two definition domains, the first knowledge inference error can be calculated.

The first example operation scheduling knowledge graphs are standard knowledge graphs used for training or verifying the performance of the entity recognition network, and contain pre-annotated entity definition domain information. For example, the operation query device 1 has one or more pre-annotated operation scheduling knowledge graphs that are used as training data to help the entity recognition network learn how to accurately identify different entities in the graphs.

In this embodiment, the first node refers to a node in the first example operation scheduling knowledge graph, typically a node that has been annotated with an entity definition domain. For example, in the first example operation scheduling knowledge graph, each node representing an operation task, computing resource, etc., is considered a first node and has a corresponding annotated entity definition domain.

In this embodiment, the first estimated definition domain refers to the estimated entity definition domain generated by the entity recognition network for a first node in the first example operation scheduling knowledge graph. For example, when the entity recognition network processes a node in the first example operation scheduling knowledge graph, it generates an estimated entity definition domain based on the features and attributes of the node, which may differ from the annotated entity definition domain.

In this embodiment, the first annotated entity definition domain refers to the correct entity definition domain pre-annotated for the first node in the first example operation scheduling knowledge graph. For example, in the first example operation scheduling knowledge graph, each node has a corresponding entity definition domain annotated by experts or standard processes, which is used as a standard to measure the performance of the entity recognition network.

In this embodiment, the prior operation scheduling knowledge graph refers to an already-existing operation scheduling knowledge graph that contains prior knowledge and is typically used as a basis for generating reconstructed operation scheduling knowledge graphs. For example, the operation query device 1 may have an operation scheduling knowledge graph constructed based on historical data and expert knowledge, which contains a large amount of prior knowledge and is the basis for constructing other knowledge graphs.

In this embodiment, knowledge reconstruction strategy refers to a strategy for transforming or reorganizing entities and relationships in the prior operation scheduling knowledge graph to generate new reconstructed operation scheduling knowledge graphs. For example, the operation query device 1 may adopt different knowledge reconstruction strategies, such as entity replacement, relationship adjustment, etc., to modify certain parts of the prior graph, thereby generating multiple different reconstructed graphs.

In this embodiment, reconstructed operation scheduling knowledge graph refers to a new knowledge graph generated by applying a knowledge reconstruction strategy to the prior operation scheduling knowledge graph. For example, the operation query device 1 may generate multiple reconstructed operation scheduling knowledge graphs, each being a different transformation or reorganization of the prior graph, used to increase data diversity and model generalization ability.

In this embodiment, the first prior entity refers to an entity in the prior operation scheduling knowledge graph that is specifically focused on or used as a basis for knowledge reconstruction. For example, in the first prior operation scheduling knowledge graph, certain key operation task or computing resource nodes may be selected as first prior entities, and the operation query device 1 applies knowledge reconstruction strategies around these entities.

In this embodiment, knowledge association parameter is a parameter describing the association relationship or similarity between entities among the first example operation scheduling knowledge graphs. For example, when the operation query device 1 compares similar entities in different knowledge graphs, it may consider parameters such as structural similarity and semantic relevance, which are knowledge association parameters.

In this embodiment, the first preset requirement is a specific standard or threshold set for the knowledge association parameter, used to determine whether the association of the first prior entity across different knowledge graphs meets the requirement. For example, the operation query device 1 may set a threshold; only when the knowledge association parameter of similar entities in two knowledge graphs exceeds this threshold does it consider that there is sufficient association between them.

In this embodiment, the operation query device 1 has already generated a target entity definition domain for each node in the target operation scheduling knowledge graph. Next, the operation query device 1 needs to use these target entity definition domains to identify the target entity in the target operation scheduling knowledge graph.

For example, the operation query device 1 identifies the corresponding target entity from the target operation scheduling knowledge graph according to the target entity definition domain of each node. This process is similar to pattern matching or searching in the target operation scheduling knowledge graph, where the operation query device 1 looks for nodes that match the target entity definition domain. Before performing entity recognition, the entity recognition network may learn and adjust its network parameters based on the first knowledge inference error. The first knowledge inference error is calculated by comparing the entity definition domains recognized by the entity recognition network (i.e., the first estimated definition domains) with the annotated entity definition domains in the knowledge graph (i.e., the first annotated entity definition domains).

In order to improve the accuracy and robustness of entity recognition, the operation query device 1 uses at least two first example operation scheduling knowledge graphs for auxiliary learning. These first example operation scheduling knowledge graphs include a prior operation scheduling knowledge graph and multiple reconstructed operation scheduling knowledge graphs generated by applying different knowledge reconstruction strategies to the prior operation scheduling knowledge graph. The entities in these first example operation scheduling knowledge graphs have knowledge association parameters that meet the first preset requirement across the graphs, meaning they have similarity or consistency in some aspects (e.g., structure, semantics, etc.).

The operation query device 1 compares the annotated entity definition domains in the first example operation scheduling knowledge graphs with the estimated definition domains recognized by the entity recognition network, thereby calculating the first knowledge inference error. The first knowledge inference error reflects the accuracy of the entity recognition network in identifying entities in the first example operation scheduling knowledge graphs and is an important basis for network parameter learning.

Based on the above steps, the disclosure acquires a target operation scheduling knowledge graph and loads it into an entity recognition network to generate a target entity definition domain associated with each target node, thereby achieving accurate identification of entities in the knowledge graph. Further, a target entity is identified from the knowledge graph according to the target entity definition domain, improving the accuracy and efficiency of entity recognition. In addition, the entity recognition network performs network parameter learning based on a first knowledge inference error calculated from differences between estimated definition domains and annotated entity definition domains for nodes in multiple example operation scheduling knowledge graphs, thereby enhancing the learning ability of the entity recognition network for entity definition. The at least two example knowledge graphs include a prior knowledge graph and reconstructed knowledge graphs generated by applying different knowledge reconstruction strategies, and the knowledge association parameters of the prior entity among these example knowledge graphs meet the preset requirement, further enriching the diversity and representativeness of learning samples and improving the generalization ability and robustness of the entity recognition network.

In other words, the disclosure acquires a target operation scheduling knowledge graph and loads it into an entity recognition network to generate a target entity definition domain associated with each target node. According to the target entity definition domain, a target entity can be identified from the target operation scheduling knowledge graph. By performing network parameter learning based on the first knowledge inference error, the entity recognition network can identify entities more accurately. Thus, using a knowledge graph and an entity recognition network improves the accuracy of entity recognition; secondly, a novel way of calculating the knowledge inference error helps optimize the network parameter learning process and improves network performance; finally, using a prior operation scheduling knowledge graph and reconstructed operation scheduling knowledge graphs makes entity recognition more consistent with preset knowledge association parameters, further improving the accuracy and efficiency of entity recognition.

In a possible implementation, generating the entity recognition network comprises the following steps:

S21: acquiring a first example operation scheduling knowledge graph sequence, the first example operation scheduling knowledge graph sequence comprising at least two first example operation scheduling knowledge graphs, the at least two first example operation scheduling knowledge graphs comprising the prior operation scheduling knowledge graph and at least two reconstructed operation scheduling knowledge graphs generated by applying at least two different knowledge reconstruction strategies to the first prior entity in the prior operation scheduling knowledge graph, wherein the knowledge association parameter of the first prior entity among the at least two first example operation scheduling knowledge graphs meets the first preset requirement, and each first example operation scheduling knowledge graph has the first annotated entity definition domain associated with each first node thereof.

In this embodiment, the operation query device 1 acquires a series of first example operation scheduling knowledge graphs from its internal storage 11 (e.g., internal database) or an external data source 12 (e.g., external cloud storage). These first example operation scheduling knowledge graphs include a prior operation scheduling knowledge graph and multiple reconstructed operation scheduling knowledge graphs. Each first example operation scheduling knowledge graph represents different aspects or scenarios of the operation scheduling field, and they are related to each other through the first prior entity. The knowledge association parameters of these first prior entities across different graphs all meet the preset standard, indicating that they have consistency and importance in the operation scheduling context.

S22: loading each of the first example operation scheduling knowledge graphs into the entity recognition network to generate the first estimated definition domain associated with each first node of the first example operation scheduling knowledge graph.

The operation query device 1 loads each acquired first example operation scheduling knowledge graph one by one into the entity recognition network. The entity recognition network scans and analyzes the nodes in each first example operation scheduling knowledge graph, attempting to understand the meaning of each node and its position in the entire first example operation scheduling knowledge graph.

For each first example operation scheduling knowledge graph loaded into the entity recognition network, the operation query device 1 uses its built-in algorithm to generate an estimated definition domain for each first node. For example, the operation query device 1 generates the estimated definition domain based on the node's attributes, connection relationships, and contextual information in the entire knowledge graph.

S23: outputting the first knowledge inference error according to the first estimated definition domain and the first annotated entity definition domain associated with each first node of the first example operation scheduling knowledge graph.

In this embodiment, the operation query device 1 compares the estimated definition domain of each first node with its corresponding annotated entity definition domain, calculates the difference or error therebetween as the first knowledge inference error, and uses this error information to measure the performance of the entity recognition network in identifying graph nodes.

S24: performing network parameter learning on the entity recognition network according to the first knowledge inference error.

Based on the calculated first knowledge inference error, the operation query device 1 adjusts and optimizes the parameters of its internal entity recognition network. For example, it can use machine learning techniques such as backpropagation to update the weights and configuration of the entity recognition network, so as to more accurately identify entities in the graph in future operation scheduling tasks.

In a possible implementation, step S24 may comprise:

S241: acquiring a second example operation scheduling knowledge graph sequence comprising at least two second example operation scheduling knowledge graphs parsed from a same operation scheduling knowledge graph, the second example operation scheduling knowledge graphs comprising a second prior entity, the second example operation scheduling knowledge graphs having a second annotated entity definition domain associated with each second node thereof.

In this embodiment, the operation query device 1 acquires the second example operation scheduling knowledge graph sequence from internal storage or an external data source. These second example operation scheduling knowledge graphs are different from the previous first example operation scheduling knowledge graphs, but they also come from the same operation scheduling field and are relevant. Each second example operation scheduling knowledge graph contains a specific second prior entity that occupies a key position in the second example operation scheduling knowledge graphs, and each second example operation scheduling knowledge graph provides an accurate second annotated entity definition domain for these second prior entities.

S242: loading each of the second example operation scheduling knowledge graphs into the entity recognition network to generate a second estimated definition domain associated with each second node of the second example operation scheduling knowledge graph.

In this embodiment, the operation query device 1 loads each acquired second example operation scheduling knowledge graph in sequence into the entity recognition network that has been preliminarily trained. The loading process ensures that the network can be exposed to more operation scheduling scenarios and entity types, thereby enhancing its generalization ability. The entity recognition network analyzes and processes each node (i.e., second node) in each newly loaded second example operation scheduling knowledge graph. For each second example operation scheduling knowledge graph loaded into the entity recognition network, the operation query device 1 uses its built-in algorithm to generate a second estimated definition domain for each second node. This estimated definition domain is generated based on the network's current learning state and understanding of the node's features, and it may differ from the actual annotated definition domain.

S243: outputting a second knowledge inference error according to the second estimated definition domain and the second annotated entity definition domain associated with each second node of the second example operation scheduling knowledge graph.

The operation query device 1 compares the second estimated definition domain of each second node with its corresponding second annotated entity definition domain to calculate the second knowledge inference error. This error reflects the accuracy of the entity recognition network when processing the second example operation scheduling knowledge graphs and provides key information for subsequent network parameter learning.

S244: performing network parameter learning on the entity recognition network according to the first knowledge inference error and the second knowledge inference error.

Combining the first knowledge inference error calculated on the first example operation scheduling knowledge graphs and the second knowledge inference error calculated on the second example operation scheduling knowledge graphs, the operation query device 1 adjusts and optimizes the parameters of the entity recognition network. This process aims to improve the overall performance of the network in identifying entities in operation scheduling knowledge graphs by integrating error information from multiple sources. For example, in some implementations, the operation query device 1 uses an optimization algorithm such as gradient descent to update the network's weights and configuration according to the magnitude and direction of the error, so as to achieve more accurate entity recognition in future operation scheduling tasks.

In a possible implementation, generating the second annotated entity definition domain in step S242 comprises: loading each of the second example operation scheduling knowledge graphs into a prior recognition network of the entity recognition network to generate a third estimated definition domain associated with each second node of the second example operation scheduling knowledge graph, and using the third estimated definition domain as the second annotated entity definition domain.

In this embodiment, the operation query device 1 begins loading each second example operation scheduling knowledge graph one by one into a specific part of the entity recognition network, called the prior recognition network. The prior recognition network may be a sub-network of the entity recognition network that is pre-trained and specifically used to generate annotated entity definition domains.

Once a second example operation scheduling knowledge graph is loaded into the prior recognition network, the operation query device 1 initiates a definition domain generation process. For each second node of the second example operation scheduling knowledge graph, the prior recognition network uses its internal algorithm and learned knowledge to generate a third estimated definition domain. Finally, the operation query device 1 directly uses the third estimated definition domain generated for each second node as the second annotated entity definition domain for that node. This means that, in this scenario, the operation query device 1 does not use externally provided annotation data, but relies on the prior recognition network's self-learning and estimation ability to generate annotated entity definition domains for each node. This approach is particularly useful when there is a lack of sufficient annotated data, as it allows the operation query device 1 to automatically annotate new data using existing knowledge and algorithms.

In this way, the operation query device 1 can autonomously generate annotated entity definition domains for each node in the second example operation scheduling knowledge graphs, which will be used for subsequent network parameter learning and knowledge inference processes.

In a possible implementation, generating the prior recognition network comprises:

Step B110: acquiring a third example operation scheduling knowledge graph sequence comprising at least two third example operation scheduling knowledge graphs, the third example operation scheduling knowledge graphs comprising a third prior entity, the third example operation scheduling knowledge graphs having a third annotated entity definition domain associated with each third node thereof, wherein a count of the third example operation scheduling knowledge graphs is greater than a count of the first example operation scheduling knowledge graphs.

In this embodiment, the operation query device 1 acquires the third example operation scheduling knowledge graph sequence from an internal database or an external data source. The third example operation scheduling knowledge graph sequence includes at least two third example operation scheduling knowledge graphs, each of which contains a third prior entity. Unlike the previous knowledge graphs, these third example operation scheduling knowledge graphs have a higher quantity, i.e., their count is greater than the count of the first example operation scheduling knowledge graphs. In addition, each third example operation scheduling knowledge graph has a third annotated entity definition domain associated with each third node thereof, and these third annotated entity definition domains are pre-annotated for subsequent learning processes.

Step B120: loading each of the third example operation scheduling knowledge graphs into the prior recognition network to generate a fourth estimated definition domain associated with each third node of the third example operation scheduling knowledge graph.

The operation query device 1 loads each acquired third example operation scheduling knowledge graph one by one into the prior recognition network that is being constructed or has been partially constructed. The loading process ensures that each node and edge in the third example operation scheduling knowledge graph is correctly processed by the network. At this stage, the prior recognition network may be in an initial state or may already have a certain degree of learning ability; it will perform further learning and optimization based on the input third example operation scheduling knowledge graphs.

Once a third example operation scheduling knowledge graph is loaded into the prior recognition network, the operation query device 1 initiates a process to generate a fourth estimated definition domain associated with each third node. This process is implemented by the network's internal algorithm and current learning state, and it attempts to generate an accurate definition domain estimate for each node. These fourth estimated definition domains may differ from the actual third annotated entity definition domains, but they are the best estimates under the network's current state.

Step B130: outputting a third knowledge inference error according to the fourth estimated definition domain and the third annotated entity definition domain associated with each third node of the third example operation scheduling knowledge graph.

The operation query device 1 compares the fourth estimated definition domain of each third node with its corresponding third annotated entity definition domain, calculates the difference therebetween as the third knowledge inference error. The third knowledge inference error reflects the accuracy of the prior recognition network when processing the third example operation scheduling knowledge graphs and is an important reference for network parameter learning.

Step B140: performing network parameter learning on the prior recognition network according to the third knowledge inference error.

Based on the calculated third knowledge inference error, the operation query device 1 adjusts and optimizes the parameters of the prior recognition network. This process may include updating network weights, adjusting network structure, or optimizing network learning algorithms. The goal of parameter learning is to reduce the inference error of the network when processing similar graphs and improve its accuracy in estimating entity definition domains. Through this process, the prior recognition network gradually learns an effective method for extracting and defining entities from operation scheduling knowledge graphs.

In a possible implementation, step S21 may comprise:

Step S210: acquiring the prior operation scheduling knowledge graph, the prior operation scheduling knowledge graph comprising the first prior entity, the prior operation scheduling knowledge graph having the first annotated entity definition domain associated with each first node thereof.

In this embodiment, the operation query device 1 first acquires the prior operation scheduling knowledge graph from its internal storage or an external data source. The prior operation scheduling knowledge graph contains rich knowledge in the field of operation scheduling and has pre-annotated first prior entities and associated first annotated entity definition domains. These first prior entities occupy key positions in the graph, and their definition domains clearly define the scope and meaning of the entities in the operation scheduling context.

Step S211: applying a knowledge reconstruction strategy under a same stage to the first prior entity and the first annotated entity definition domain in the prior operation scheduling knowledge graph to generate a reconstructed operation scheduling knowledge graph subsequent to the prior operation scheduling knowledge graph and an associated first annotated entity definition domain, wherein the knowledge association parameter of the first prior entity between the prior operation scheduling knowledge graph and the reconstructed operation scheduling knowledge graph meets the first preset requirement.

The operation query device 1 then performs a knowledge reconstruction strategy on the acquired prior operation scheduling knowledge graph. This strategy is specifically designed for the first prior entity and the first annotated entity definition domain, aiming to reorganize and express the knowledge in the prior operation scheduling knowledge graph without changing the essential meaning of the entities. By applying this strategy, the operation query device 1 generates a new version subsequent to the prior operation scheduling knowledge graph, called the reconstructed operation scheduling knowledge graph, while retaining the first annotated entity definition domains associated with the entities in the original prior operation scheduling knowledge graph. During this process, the knowledge association parameter of the first prior entity between the prior operation scheduling knowledge graph and the reconstructed operation scheduling knowledge graph is ensured to meet the first preset requirement, which guarantees consistency and accuracy of knowledge during reconstruction.

Step S212: applying the knowledge reconstruction strategy under the same stage to the first prior entity and the first annotated entity definition domain in the reconstructed operation scheduling knowledge graph to generate an iterative reconstructed operation scheduling knowledge graph, wherein the knowledge association parameter of the first prior entity between associated reconstructed operation scheduling knowledge graphs meets the first preset requirement.

The operation query device 1 continues to apply the same knowledge reconstruction strategy to the reconstructed operation scheduling knowledge graph. This time, the knowledge reconstruction strategy is applied to the already reconstructed first prior entity and first annotated entity definition domain in the reconstructed operation scheduling knowledge graph. This process iteratively generates new reconstructed operation scheduling knowledge graphs, ensuring at each iteration that the knowledge association parameter of the first prior entity between associated reconstructed operation scheduling knowledge graphs meets the first preset requirement. This iterative reconstruction method helps to gradually optimize and refine the knowledge expression in the graphs.

Step S213: cyclically performing step S212 until the count of reconstructed operation scheduling knowledge graphs meets a second preset requirement, and determining the first example operation scheduling knowledge graph sequence based on the prior operation scheduling knowledge graph and at least two reconstructed operation scheduling knowledge graphs.

The operation query device 1 cyclically performs the step of applying the knowledge reconstruction strategy to the first prior entity and the first annotated entity definition domain in the reconstructed operation scheduling knowledge graph. This cyclic process continues until the number of generated reconstructed operation scheduling knowledge graphs meets the second preset requirement. The second preset requirement may be a specific threshold for the number of graphs or a quality standard for reconstruction determined based on some evaluation metric. Once the requirement is met, the operation query device 1 stops the cycle and determines the first example operation scheduling knowledge graph sequence based on the original prior operation scheduling knowledge graph and at least two reconstructed operation scheduling knowledge graphs generated through reconstruction. The first example operation scheduling knowledge graph sequence forms the basic data set for subsequent learning and inference.

In a possible implementation, determining that the knowledge association parameter of the first prior entity among the at least two first example operation scheduling knowledge graphs meets the first preset requirement comprises:

Step C110: for each prior node of the first prior entity on the prior operation scheduling knowledge graph, obtaining a stage at which the prior node is located in each of the at least two first example operation scheduling knowledge graphs.

In this embodiment, the operation query device 1 first focuses on the first prior entity in the prior operation scheduling knowledge graph. For each prior node in this entity, the operation query device 1 checks its position in at least two first example operation scheduling knowledge graphs. Specifically, the operation query device 1 determines the stage at which these prior nodes are located in each first example operation scheduling knowledge graph. These stages may be different phases, tasks, or subtasks in the operation scheduling process, which together form the complete flow of operation scheduling.

Step C120: if, for each said prior node, a deviation between the stages at which the prior node is located in any two of the first example operation scheduling knowledge graphs is less than a first set deviation, outputting that the knowledge association parameter of the first prior entity among the at least two first example operation scheduling knowledge graphs meets the first preset requirement.

The operation query device 1 then compares the difference in the stages at which each prior node is located in any two first example operation scheduling knowledge graphs. This difference is referred to as the deviation, which measures the degree of change in the position or role of the same prior node across different graphs. The operation query device 1 calculates the deviation for each prior node and compares it with a preset first set deviation.

For example, if the operation query device 1 finds that for each prior node, the deviation between any two first example operation scheduling knowledge graphs is less than the first set deviation, this means that these first example operation scheduling knowledge graphs maintain a high degree of consistency when describing the first prior entity. In other words, the knowledge association parameters of these first example operation scheduling knowledge graphs meet the first preset requirement.

Finally, the operation query device 1 outputs a determination result indicating whether the knowledge association parameter of the first prior entity among the at least two first example operation scheduling knowledge graphs meets the first preset requirement. This determination result will serve as a basis for subsequent processing or decision-making, ensuring the accuracy and reliability of the operation scheduling knowledge graphs.

In a possible implementation, determining that the knowledge association parameter of the first prior entity among the at least two first example operation scheduling knowledge graphs meets the first preset requirement comprises:

Step D110: decomposing each of the first example operation scheduling knowledge graphs into operation scheduling knowledge units, and assigning a unit label to each operation scheduling knowledge unit according to a participating stage of the operation scheduling knowledge unit.

In this embodiment, the operation query device 1 begins processing each first example operation scheduling knowledge graph, first decomposing these complex first example operation scheduling knowledge graphs into smaller, more manageable parts called operation scheduling knowledge units. These operation scheduling knowledge units may represent specific steps, tasks, or subtasks in the operation scheduling process, and each operation scheduling knowledge unit contains specific knowledge directly related to operation scheduling.

After decomposing the first example operation scheduling knowledge graphs, the operation query device 1 assigns a unit label to each operation scheduling knowledge unit. The unit label is determined based on the participating stage of the unit in the operation scheduling process. For example, if a knowledge unit describes a resource allocation stage, it may be assigned a label related to resource allocation. These unit labels help the operation query device 1 quickly identify and classify different operation scheduling knowledge units.

Step D120: if the first prior entity is located in the operation scheduling knowledge unit associated with the same unit label in each of the first example operation scheduling knowledge graphs, outputting that the knowledge association parameter of the first prior entity among the at least two first example operation scheduling knowledge graphs meets the first preset requirement.

Next, the operation query device 1 checks the position of the first prior entity in each first example operation scheduling knowledge graph. The operation query device 1 specifically focuses on whether this entity appears in an operation scheduling knowledge unit having the same unit label. This is because if the first prior entity appears in the same type of knowledge unit across different graphs, it may indicate that the graphs maintain consistency when describing this entity.

The operation query device 1 compares the position of the first prior entity in each first example graph. If the operation query device 1 finds that the first prior entity is located in an operation scheduling knowledge unit having the same unit label in each first example graph, this means that the graphs have a high degree of consistency when describing this entity.

Finally, if the above condition is satisfied, the operation query device 1 outputs a determination result indicating that the knowledge association parameter of the first prior entity among the at least two first example operation scheduling knowledge graphs meets the first preset requirement. This determination result is based on the analysis of the entity's consistency across different graphs and demonstrates the accuracy and reliability of these graphs in describing the first prior entity. If the condition is not satisfied, the operation query device 1 may output a determination result indicating non-conformance, or take other measures such as re-analyzing the graphs or updating the knowledge association parameters.

In a possible implementation, the target operation scheduling knowledge graph comprises a plurality of continuous target operation scheduling knowledge graphs, the target entity definition domain comprises a target entity definition subdomain for each of the target operation scheduling knowledge graphs, and step S210 may comprise:

Step S211: for a currently traversed target operation scheduling knowledge graph, acquiring a previously generated target operation scheduling knowledge graph and a target entity definition subdomain of the previously generated target operation scheduling knowledge graph.

Step S212: loading the currently traversed target operation scheduling knowledge graph, the previously generated target operation scheduling knowledge graph, and the target entity definition subdomain of the previously generated target operation scheduling knowledge graph into the entity recognition network to generate a target entity definition subdomain associated with each target node of the currently traversed target operation scheduling knowledge graph.

In this embodiment, the operation query device 1 begins processing the currently traversed target operation scheduling knowledge graph. Before processing, it first acquires the target operation scheduling knowledge graph generated in the previous traversal and the associated target entity definition subdomain. These previously generated knowledge graph and entity definition subdomain are the results obtained by the operation query device 1 in the previous round of processing, and they will serve as input data for the current round of processing.

The operation query device 1 then loads the currently traversed target operation scheduling knowledge graph, the previously generated target operation scheduling knowledge graph, and the previously generated target entity definition subdomain together into the entity recognition network.

After loading the relevant data into the entity recognition network, the operation query device 1 runs the recognition algorithm of the entity recognition network to generate a target entity definition subdomain associated with each target node of the currently traversed target operation scheduling knowledge graph. These target entity definition subdomains are automatically generated by the entity recognition network based on the structural and relational information in the graph, and they can accurately describe the role and meaning of each target node in the graph.

Through the above steps, the operation query device 1 can perform entity recognition and definition domain generation on the target operation scheduling knowledge graph using the entity recognition network, providing accurate basic data for subsequent knowledge graph analysis and application. At the same time, by iteratively traversing and processing the knowledge graphs, the operation query device 1 can gradually optimize and improve the performance of the entity recognition network, improving the accuracy and efficiency of entity recognition.

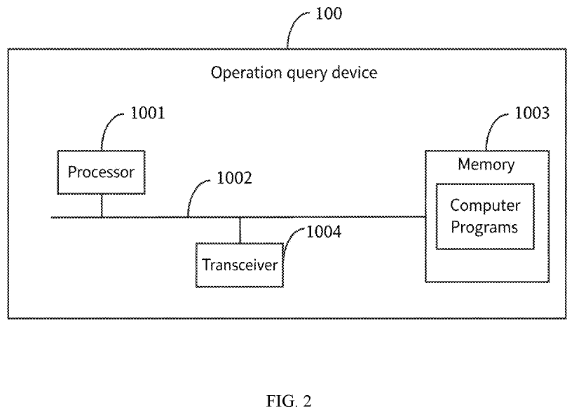

FIG. 2 shows an operation query device 1100 provided in an embodiment of the disclosure, comprising a processor 1001 and a memory 1003 and program code stored on the memory 1003, wherein the processor 1001 executes the program code to implement the steps of the knowledge graph-based information processing method.

The operation query device 100 shown in the FIG. 2 includes: a processor 1001 and a memory 1003. The processor 1001 and the memory 1003 are connected, for example, via a bus 1002. Optionally, the operation query device 1100 may further include a transceiver 1004, which can be used for data interaction between the operation query device 100 and other operation query devices, such as data transmission and/or data reception. It should be noted that in actual scheduling, the transceiver 1004 is not limited to one, and the structure of the operation query device 100 does not constitute a limitation on the embodiments of the disclosure.

The processor 1001 may be a CPU (Central Processing Unit), a general-purpose processor, a DSP (Digital Signal Processor), an ASIC (Application Specific Integrated Circuit), an FPGA (Field Programmable Gate Array) or other programmable logic devices, transistor logic devices, hardware components, or any combination thereof. It may implement or execute various exemplary logical blocks, modules, and circuits described in conjunction with the disclosure of the disclosure. The processor 1001 may also be a combination that implements computing functions, such as a combination of one or more microprocessors, a combination of a DSP and a microprocessor, etc.

The bus 1002 may include a path for transferring information between the above components. The bus 1002 may be a PCI (Peripheral Component Interconnect) bus or an EISA (Extended Industry Standard Architecture) bus, etc. The bus 1002 may be divided into an address bus, a data bus, a control bus, etc.

The memory 1003 may be a ROM (Read Only Memory) or other type of static storage device that can store static information and instructions, a RAM (Random Access Memory) or other type of dynamic storage device that can store information and instructions, or an EEPROM (Electrically Erasable Programmable Read Only Memory), a CD-ROM (Compact Disc Read Only Memory) or other optical disc storage, optical disc storage (including compact discs, laser discs, optical discs, digital versatile discs, Blu-ray discs, etc.), magnetic disk storage media, other magnetic storage devices, or any other medium that can be used to carry or store program code and that can be read by a computer, without limitation herein.

The memory 1003 is used to store program code for executing the embodiments of the disclosure, and the execution is controlled by the processor 1001. The processor 1001 is used to execute the program code stored in the memory 1003 to implement the steps shown in the foregoing method embodiments.

In one embodiment, the operation query device 100 provided by the disclosure may be implemented in the form of a computer program, such as a non-volatile storage medium, which can be run on a computer device. The memory of the computer device may store various program modules constituting the operation query device, for example, the acquisition module, determination module, matching module, and fusion module. The computer program composed of the various program modules causes the processor to execute the steps in the knowledge graph-based information processing method of various embodiments of the disclosure described in this specification.

It should be understood that although the flowcharts of the embodiments of the disclosure indicate various operation steps with arrows, the order of execution of these steps is not limited to the order indicated by the arrows. Unless explicitly stated otherwise herein, in some implementation scenarios of the embodiments of the disclosure, the implementation steps in each flowchart may be executed in another order as required. In addition, some or all of the steps in each flowchart may include multiple sub-steps or multiple stages according to actual implementation scenarios. Some or all of these sub-steps or stages may be executed at the same time, and each of these sub-steps or stages may also be executed at different times. In scenarios where the execution times are different, the order of execution of these sub-steps or stages may be flexibly configured as required, which is not limited by the embodiments of the disclosure.

The above are only optional implementation manners of some implementation scenarios of the disclosure. It should be pointed out that for those of ordinary skill in the art, without departing from the technical concept of the solutions of the disclosure, other similar implementation means based on the technical idea of the disclosure also fall within the protection scope of the embodiments of the disclosure.

1. A computer device, comprising a processor and a non-volatile computer-readable storage medium storing machine-executable instructions that, when executed by the processor, implement a knowledge graph-based information processing method comprising:
acquiring, by the processor, a target operation scheduling knowledge graph, and loading the target operation scheduling knowledge graph into an entity recognition network to generate a target entity definition domain associated with each target node of the target operation scheduling knowledge graph; and
identifying a target entity from the target operation scheduling knowledge graph according to the target entity definition domain, wherein the entity recognition network performs network parameter learning based on a first knowledge inference error, the first knowledge inference error being calculated according to a first estimated definition domain recognized by the entity recognition network for each first node in at least two first example operation scheduling knowledge graphs and a first annotated entity definition domain for each said first node, the at least two first example operation scheduling knowledge graphs comprising a prior operation scheduling knowledge graph and at least two reconstructed operation scheduling knowledge graphs generated by applying at least two different knowledge reconstruction strategies to a first prior entity in the prior operation scheduling knowledge graph, wherein a knowledge association parameter of the first prior entity among the at least two first example operation scheduling knowledge graphs meets a first preset requirement;
wherein determining that the knowledge association parameter of the first prior entity among the at least two first example operation scheduling knowledge graphs meets the first preset requirement comprises:
for each prior node of the first prior entity on the prior operation scheduling knowledge graph, obtaining a stage at which the prior node is located in each of the at least two first example operation scheduling knowledge graphs; and if, for each of the prior node, a deviation between the stages at which the prior node is located in any two of the first example operation scheduling knowledge graphs is less than a first set deviation, outputting that the knowledge association parameter of the first prior entity among the at least two first example operation scheduling knowledge graphs meets the first preset requirement, wherein the first prior entity is an entity that is specifically focused on or used as a basis for knowledge reconstruction in the prior operation scheduling knowledge graph, and the stage is a different phase, task, or subtask in an operation scheduling process;
or, decomposing each of the first example operation scheduling knowledge graphs into operation scheduling knowledge units, and assigning a unit label to each operation scheduling knowledge unit according to a participating stage of the operation scheduling knowledge unit; and if the first prior entity is located in the operation scheduling knowledge unit associated with the same unit label in each of the first example operation scheduling knowledge graphs, outputting that the knowledge association parameter of the first prior entity among the at least two first example operation scheduling knowledge graphs meets the first preset requirement.

2. The computer device of claim 1, wherein performing network parameter learning on the entity recognition network according to the first knowledge inference error comprises:
acquiring a second example operation scheduling knowledge graph sequence comprising at least two second example operation scheduling knowledge graphs parsed from a same operation scheduling knowledge graph, the second example operation scheduling knowledge graphs comprising a second prior entity, the second example operation scheduling knowledge graphs having a second annotated entity definition domain associated with each second node thereof, wherein the second prior entity occupies a key position in the second example operation scheduling knowledge graphs;
loading each of the second example operation scheduling knowledge graphs into the entity recognition network to generate a second estimated definition domain associated with each second node of the second example operation scheduling knowledge graph;
outputting a second knowledge inference error according to the second estimated definition domain and the second annotated entity definition domain associated with each second node of the second example operation scheduling knowledge graph; and
performing network parameter learning on the entity recognition network according to the first knowledge inference error and the second knowledge inference error.

3. The computer device of claim 2, wherein generating the second annotated entity definition domain comprises:
loading each of the second example operation scheduling knowledge graphs into a prior recognition network of the entity recognition network to generate a third estimated definition domain associated with each second node of the second example operation scheduling knowledge graph, and using the third estimated definition domain as the second annotated entity definition domain.

4. The computer device of claim 3, wherein generating the prior recognition network comprises:
acquiring a third example operation scheduling knowledge graph sequence comprising at least two third example operation scheduling knowledge graphs, the third example operation scheduling knowledge graphs comprising a third prior entity, the third example operation scheduling knowledge graphs having a third annotated entity definition domain associated with each third node thereof, wherein a count of the third example operation scheduling knowledge graphs is greater than a count of the first example operation scheduling knowledge graphs;
loading each of the third example operation scheduling knowledge graphs into the prior recognition network to generate a fourth estimated definition domain associated with each third node of the third example operation scheduling knowledge graph;
outputting a third knowledge inference error according to the fourth estimated definition domain and the third annotated entity definition domain associated with each third node of the third example operation scheduling knowledge graph; and
performing network parameter learning on the prior recognition network according to the third knowledge inference error.

5. The computer device of claim 1, wherein acquiring the first example operation scheduling knowledge graph sequence comprises:
acquiring the prior operation scheduling knowledge graph, the prior operation scheduling knowledge graph comprising the first prior entity, the prior operation scheduling knowledge graph having the first annotated entity definition domain associated with each first node thereof;
applying a knowledge reconstruction strategy under a same stage to the first prior entity and the first annotated entity definition domain in the prior operation scheduling knowledge graph to generate a reconstructed operation scheduling knowledge graph subsequent to the prior operation scheduling knowledge graph and an associated first annotated entity definition domain, wherein the knowledge association parameter of the first prior entity between the prior operation scheduling knowledge graph and the reconstructed operation scheduling knowledge graph meets the first preset requirement, and the knowledge reconstruction strategy under the same stage is designed for the first prior entity and the first annotated entity definition domain to reorganize and express knowledge in the prior operation scheduling knowledge graph without changing an essential meaning of the entity;
applying the knowledge reconstruction strategy under the same stage to the first prior entity and the first annotated entity definition domain in the reconstructed operation scheduling knowledge graph to generate an iterative reconstructed operation scheduling knowledge graph, wherein the knowledge association parameter of the first prior entity between associated reconstructed operation scheduling knowledge graphs meets the first preset requirement;
cyclically performing the step of applying the knowledge reconstruction strategy under the same stage to the first prior entity and the first annotated entity definition domain in the reconstructed operation scheduling knowledge graph to generate an iterative reconstructed operation scheduling knowledge graph until a count of reconstructed operation scheduling knowledge graphs meets a second preset requirement; and
determining the first example operation scheduling knowledge graph sequence based on the prior operation scheduling knowledge graph and at least two reconstructed operation scheduling knowledge graphs.

6. The computer device of claim 1, wherein the target operation scheduling knowledge graph comprises a plurality of continuous target operation scheduling knowledge graphs, the target entity definition domain comprises a target entity definition subdomain for each of the target operation scheduling knowledge graphs, and loading the target operation scheduling knowledge graph into the entity recognition network to generate the target entity definition domain associated with each target node of the target operation scheduling knowledge graph comprises:
for a currently traversed target operation scheduling knowledge graph, acquiring a previously generated target operation scheduling knowledge graph and a target entity definition subdomain of the previously generated target operation scheduling knowledge graph; and
loading the currently traversed target operation scheduling knowledge graph, the previously generated target operation scheduling knowledge graph, and the target entity definition subdomain of the previously generated target operation scheduling knowledge graph into the entity recognition network to generate a target entity definition subdomain associated with each target node of the currently traversed target operation scheduling knowledge graph.
